(19) United States
(12) Patent Application Publication
(10) Pub. No.: US 2014/0176945 A1
(43) Pub. Date: Jun. 26, 2014

(54) ALIGNING MODULE AND METHOD FOR ASSEMBLING LIGHT-EMITTING DIODE WITH LENS USING THE SAME

(71) Applicant: HON HAI PRECISION INDUSTRY CO., LTD., New Taipei (TW)

(72) Inventor: CHIH-CHEN LAI, New Taipei (TW)

(73) Assignee: HON HAI PRECISION INDUSTRY CO., LTD., New Taipei (TW)

(21) Appl. No.: 14/010,540

(22) Filed: Aug. 27, 2013

(30) Foreign Application Priority Data
Dec. 24, 2012 (TW) 101149452

(51) Int. Cl. G01B 11/27

(52) U.S. Cl. CPC G01B 11/272
USPC 356/400

(57) ABSTRACT

An exemplary aligning module for aligning a lens with a light-emitting diode (LED) chip includes a controlling module, a first image sensing module and a second image sensing module controlled by the controlling module, and a gripping module controlled also by the controlling module. The controlling module controls the first image sensing module and the second image sensing module to sense the light center of the LED chip and the geometric center of the lens, respectively. The controlling module controls the gripping module to bring the geometry center of lens to be aligned precisely with the light center of the LED chip according to a coordinate of the light center the LED and a coordinate of the geometric center of the lens. The present disclosure also relates to a method for aligning a lens with a light emitting diode chip.

### BACKGROUND

1. Technical Field

The disclosure generally relates to aligning modules, particularly, to an aligning module for aligning a lens with a light emitting diode chip and a method for aligning the lens with the light emitting diode chip using the aligning module.

2. Description of Related Art

A conventional light emitting diode (LED) package includes a substrate, an LED chip arranged on the substrate, and a lens covering the LED chip and aligned with the LED chip.

A conventional method for aligning the LED chip and the lens is applied by following steps: providing a first image sensor to sensor the geometric center of the outline of the LED chip; providing a second image sensor to sensor the geometric center of the outline of the lens; aligning the LED chip with the lens by aligning the geometric center of the LED chip with the geometric center of the lens. However, because of some factors in the process of manufacturing the LED chip, such as a poor precision, the light center with the highest light intensity of the LED chip is not aligned with the geometric center of the LED chip. Therefore, even the geometric center of the LED chip is aligned with the geometric center of the lens, the light center of the LED chip is still not aligned with the geometric center of the lens, which adversely affects the performance of the LED package.

What is needed, therefore, is an aligning module and a method for aligning a light emitting diode with a lens.

### BRIEF DESCRIPTION OF THE DRAWINGS

FIG. 1 is a front side view showing an aligning module in accordance with an exemplary embodiment of the present disclosure.

FIGS. 2-4 are schematic views showing the steps of aligning a light emitting diode with a lens using the aligning module of FIG. 1.

### DETAILED DESCRIPTION

An aligning module for aligning a light emitting diode with a lens in accordance with an exemplary embodiment of the present disclosure will now be described in detail below and with reference to the drawings.

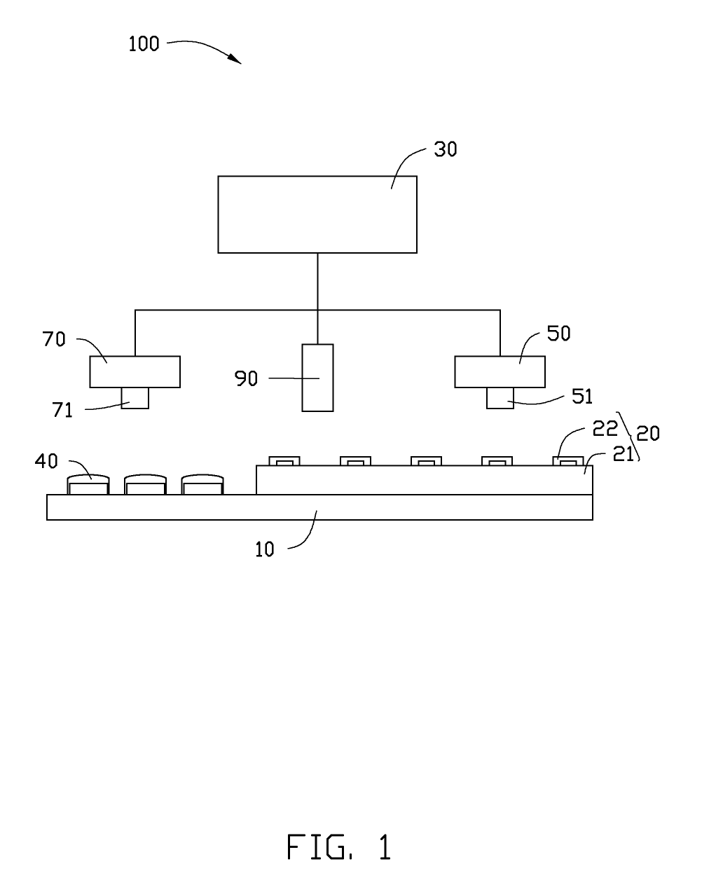

Referring to FIG. 1, an aligning module 100, in accordance with an exemplary embodiment, is provided. The aligning module 100 includes a platform 10, a controlling module 30, a first image sensing module 50 and a second image sensing module 70 controlled by the controlling module 30, and a gripping module 90 also controlled by the controlling module 30.

The platform 10 supports an LED module 20 and a plurality of lenses 40 located on a top surface of the platform 10. The LED module 20 includes a substrate 21 and a plurality of LED chips 22 arranged on a top surface of the substrate 21. The LED chips 22 electrically connect with a circuit (not shown) on the top surface of the substrate 21.

The controlling module 30 controls the first and second image sensing modules 50, 70 to capture images of the LED chips 22 and the lenses 40 respectively.

The first image sensing module 50 can capture the image of the LED chip 22, and can store the captured image in a storage device, such as a writable/readable optical disk (not illustrated) or a solid-state memory module (not illustrated). The first image sensing module 50 includes a first charged coupled device (CCD) sensor 51. In this embodiment, the first image sensing module 50 is used to capture the image of the light intensity distribution of the LED chip 22.

Similarly, the second image sensing module 70 can capture an image of the lens 40, and can store the captured in another storage device such as a writable/readable optical disk (not illustrated) or a solid-state memory module (not illustrated). The second image sensing module 50 includes a second charged coupled device (CCD) 71. In this embodiment, the second image sensing module 70 is used to capture the image of an outline of the lens 40.

In this embodiment, the gripping module 90 is controlled by the controlling module 30 to pick up the lens 40 to align the lens 40 with the LED chip 22, and mount the lens 40 on the substrate 21 to cover the LED chip 22.

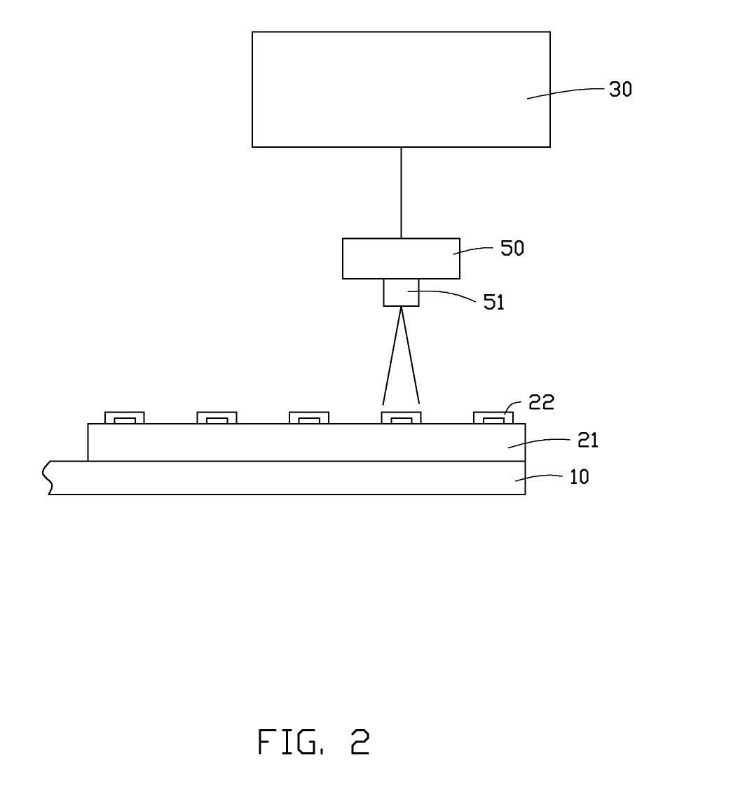

Referring to FIGS. 2-4, a method for aligning the LED chip 22 and the lens 40 using the aligning module 100 is provided, and includes following steps:

Referring to FIG. 2, the first step is providing a plurality of LED chips 22 on the platform 10, and supplying current to the LED chips 22 to cause the LED chips 22 to emit light.

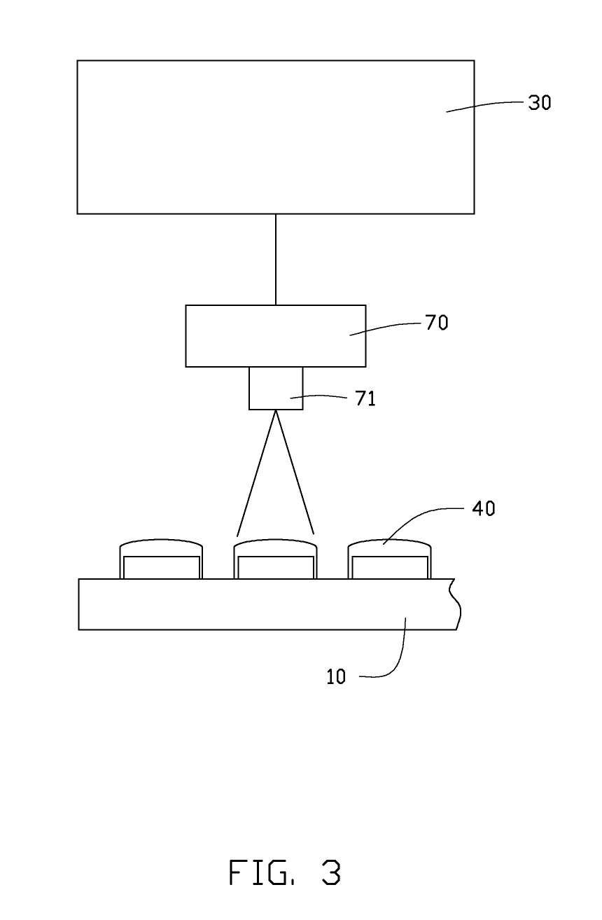

Referring to FIG. 3, the second step is providing the aligning module 100 to obtain a coordinate of the light center of the LED chip 22 and the coordinate of the geometric center of the lens 40. In detail, the first image sensing module 50 is controlled by the controlling module 30 to capture the image of the light intensity distribution of the LED chip 22. The second image sensing module 70 is controlled by the controlling module 30 to capture the image of the outline of the lens 40. The first and second image sensing modules 50, 70 stores the images captured in the storage devices respectively, which are for example, optical dicks or solid-state memory modules. The controlling module 30 reads the captured image by the first image sensing module 50, and calculates the coordinate of the light center with a highest light intensity of the LED chip 22. The controlling module 30 reads the captured image by the second image sensing module 70, and calculates the coordinate of the geometric center of the lens 40. In this embodiment, the coordinate of the light center of the LED chip 22 is the coordinate where the light intensity of the LED chip 22 is the highest.

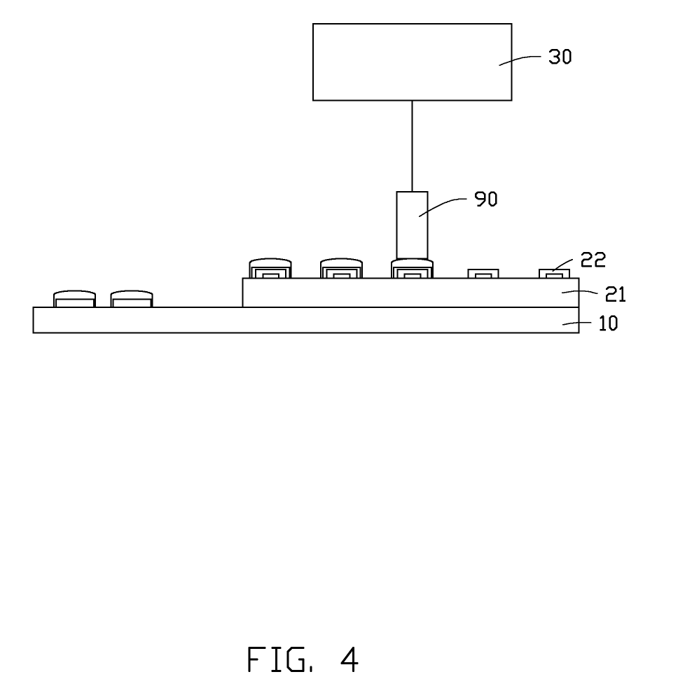

Referring to FIG. 4, the third step is aligning the lens 40 with the LED chip 22, and mounting the lens 40 on the substrate 21 to cover the LED chip 22. In this embodiment, the controlling module 30 controls the gripping module 90 to pick up the lens 40 to align the geometric center of the lens 40 with the light center of the LED chip 22 according the coordinates of the geometric center of the lens 40 and the light center of the LED chip 22, and then, mount the lens 40 on the substrate 21 to cover the LED chip 22.

According to the aligning module 100 and the method for aligning the LED chip 22 with the lens 40, because the light center of the LED chip 22 is aligned with the geometric center of the lens 40, light emitted from the LED chip 22 can radiate towards the periphery of the lens 40 evenly, and the performance of the LED module 20 with the lens 40 is improved.

It is to be understood that the above-described embodiments are intended to illustrate rather than limit the disclosure. Variations may be made to the embodiments without departing from the spirit of the disclosure as claimed. The above-described embodiments illustrate the scope of the disclosure but do not restrict the scope of the disclosure.

What is claimed is:

1. An aligning module for aligning a light emitting diode (LED) chip with a lens comprising:
a controlling module; and
a plurality of image sensing modules controlled by the controlling module, the controlling module controlling the image sensing modules to obtain the coordinate of the light center of the LED chip and the coordinate of the geometric center of the lens, and the lens being aligned with the LED chip with the geometric center of the lens being aligned with the light center of the LED chip.

2. The aligning module of claim 1 further comprises a gripping module, and the gripping module is controlled by the controlling module to pick up the lens to align with the LED chip according to the coordinates of the geometric center of the lens and the light center of the LED chip.

3. The aligning module of claim 1, wherein the image sensing module comprises a first image sensing module and a second image sensing module, the first image sensing module is controlled by the controlling module to capture the image of the light intensity distribution of the LED chip, and the second image sensing module is controlled by the controlling module to capture the image of the outline of the lens.

4. The aligning module of claim 3, wherein the controlling module obtains the coordinate of the light center of the LED chip by calculating the captured image stored in the first image sensing module, and the controlling module obtains the coordinate of the geometric center of the lens by calculating the captured image stored in the second image sensing module.

5. The aligning module of claim 1, wherein the first image sensing module comprises a charged coupled device (CCD), and the second image sensing module comprises a charged coupled device (CCD).

6. A method for aligning a light emitting diode (LED) chip with a lens comprising following steps:
S1: providing a plurality of LED chips on a platform, and supplying current to the LED chips to cause the LED chips to emit light;
S2: obtaining the coordinate of the light center of the LED chip and the coordinate of the geometric center of the lens;
S3: aligning the lens with the LED chip by aligning the geometric center of the lens with the light center of the LED chip.

7. The method of claim 6, wherein step S3 further comprises: providing a gripping module controlled by the aligning module, wherein the gripping module picks up the lens to be aligned with the LED chip and then mounts the lens on the LED chip.

8. The method of claim 6, wherein an aligning module is provided to obtain the coordinated of the light center of the LED chip and the coordinate of the geometric center of the lens, and the aligning module comprises a controlling module, a first image sensing module and a second image sensing module, the first image sensing module is controlled by the controlling module to capture the image of the light intensity distribution of the LED chip, the second image sensing module is controlled by the controlling module to capture the image of the outline of the lens, and the first and second image sensing modules store the images captured in their storage devices respectively.

9. The method of claim 8, wherein the controlling module reads the captured image by the first image sensing module, and calculates the coordinate of the light center with a highest light intensity of the LED chip, the controlling module reads the captured image by the second image sensing module, and calculates the coordinate of the geometric center of the lens.
